(19) United States
(12) Patent Application Publication
(10) Pub. No.: US 2013/0097047 A1
(43) Pub. Date: Apr. 18, 2013

(54) AUTHENTICATION SERVER

(71) Applicant: Seok Ki KIM, Chung Hum Kok (HK)

(72) Inventor: Seok Ki KIM, Chung Hum Kok (HK)

(21) Appl. No.: 13/273,969

(22) Filed: Oct. 14, 2011

(51) Int. Cl. G06Q 30/06

(52) U.S. Cl. 705/26.4; 705/26.41

(57) ABSTRACT

An apparatus for use as an authentication server can include a first interface configured to communicate with a first user. The apparatus can also include a second interface configured to communicate with a second user. The apparatus can further includes an authentication controller configured to authenticate the first user based on a first deposit of a first item, authenticate the second user based on a second deposit of a second item, transfer the first deposit to a first pool, wherein the first pool contains a plurality of the first item, transfer the second deposit to a second pool wherein the second pool contains a plurality of the second item, authenticate an exchange transaction between the first user and the second user, transfer a third item from the first pool to the second user, and transfer a fourth item from the second pool to the first user.

### BACKGROUND

1. Field

An authentication server can provide security between parties. For example, an authentication server can be used to secure the transfer of property from a first party to a second party.

2. Description of the Related Art

Computer gaming markets ($125 billion in 2010) have already surpassed the music and movies markets combined ($117 billion in 2010). On-line games, such as massively multiplayer on-line role playing games (MMORPGs) are growing at particularly high rate (>20% per year).

Purchase of “items” for use within the games contributes to the size of the computer gaming markets. These items include, for example, game gold or game money, special swords and weapons, and sometimes even properties, such as castles.

Gamers or players (people who play the games) typically accumulate significant amounts of play-time and credit in order to acquire such valuable items, and such items are often traded for real money. The markets for trading such items are already quite big: estimated to be $8.25 billion in 2010 ($1.5 billion for Korea; $4.0 billion for China; and $2.4 billion for USA, Europe, Japan). The actual trading volume is estimated to be even bigger than this number, because there are numerous unreported trades.

Typically, potential buyers and sellers meet on-line (e.g., chatting sites); agree on items and price; agree on face-to-face (i.e. within the game) meeting for settlement; and execute the exchange in their on-line games.

### SUMMARY

An apparatus according to certain embodiments can be for use as an authentication server. The apparatus includes a first interface configured to communicate with a first user. The apparatus also includes a second interface configured to communicate with a second user. The apparatus further includes an authentication controller configured to authenticate the first user based on a first deposit of a first item, authenticate the second user based on a second deposit of a second item, transfer the first deposit to a first pool, wherein the first pool contains a plurality of the first item, transfer the second deposit to a second pool wherein the second pool contains a plurality of the second item, authenticate an exchange transaction between the first user and the second user, transfer a third item from the first pool to the second user, and transfer a fourth item from the second pool to the first user.

According to certain embodiments, an apparatus for authenticating a transaction can include an authentication controller configured to broker an exchange between a buyer and a seller. The buyer and the seller are in communication with a persistent world. The authentication controller is configured to generate in-game characters for communicating with the buyer and seller in the persistent world, authenticate the seller based on a first item received from the seller by way of a first generated in-game character configured to communicate with the seller in the persistent world, transfer the first item to a first storage containing a plurality of the first item, transfer virtual currency from a buyer from a first external account outside the persistent world to an escrow account, authenticate an exchange transaction between the buyer and the seller, wherein the exchange transaction is performed based on matching an asking price from the seller with an offer price from the buyer, transfer the first item from the first storage to the buyer by way of a second generated in-game character configured to communicate with the buyer in the persistent world, and transfer virtual currency to a second external account linked to the seller outside the persistent world.

### BRIEF DESCRIPTION OF THE DRAWINGS

For proper understanding of the invention, reference should be made to the accompanying drawings, wherein:

FIG. 1 illustrates a system according to certain embodiments.

FIG. 2 illustrates a partially integrated system according to certain embodiments.

FIG. 3 illustrates a flow diagram of functionality according to certain embodiments.

FIG. 4 illustrates automated item transfer according to certain embodiments.

FIG. 5 illustrates an automated item deposit according to certain embodiments.

FIG. 6 illustrates an apparatus according to certain embodiments.

FIG. 7 illustrates a method according to certain embodiments.

FIG. 8 illustrates a credit transfer process according to certain embodiments.

FIG. 9 illustrates a credit exchange process according to certain embodiments.

### DETAILED DESCRIPTION

Various embodiments can provide a security mechanism for protection of parties in a communication or trading transaction. This security mechanism can be implemented using, among other things, an authentication server.

According to certain embodiments, the major functionalities of a virtual account, a trading system, and a payment gateway can be integrated. These functionalities can be implemented by a single authentication server or by multiple servers operating in connection with one another.

The virtual account functionality can provide an account that includes virtual currencies (a first kind of “item” as described herein) and/or in-game items (another kind of “item” as described here). Both kinds of items can be used in transactions and/or purchases on the overall system.

A virtual account can also be termed a pool. The pool can be a pool of an individual user, a pool of the owner or operator of the authentication server or whole system, or an escrow pool possessed by the operator of the authentication server but on behalf of the individual user. In this discussion it should be understood that “individual user” can also refer to groups of users that form a partnership, association, tribe, guild, co-op, collective, or other agreement for combined action. Thus, “individual user” can even refer to a corporate entity that has an account on the system.

Furthermore, the term “character” can refer to a virtual representation of an individual user (as defined above) in a gaming environment, e.g., an avatar. Examples of characters include a player character, broker character, delivery character, buyer character, seller character, coordinate character, and so on.

The virtual account functionality can include account management and checking balances. Thus, for example, credit or debit of virtual currency, game money or other items can be performed. Likewise, a transaction history can be maintained and provided to the owner of the account or to the owner of the system.

The virtual account functionality can also include virtual currency transfer. This currency transfer can be person to person or to a bank account. Likewise, the virtual account functionality can include virtual currency to cash exchange. This exchange can permit the recharging of credit in virtual currency, for example, the purchase of additional virtual currency using real money, or the withdrawal of real money from an account of virtual currency.

The trading system functionality can be a system that trades in-game items and other digital contents for virtual currency. This functionality can, in turn, encompass the functionality of auto-matching trades. For example, “buy” prices for items can be matched to “sell” prices for items.

The trading system functionality can also include an operations system for instant trade and deposit features. This trading system can be independent and stand/alone from any particular game. This trading system, however, can also or alternatively be integrated with or into a particular game through, for example, an application programming interface (API).

The trading system functionality can further include statistical capabilities. For example, the trading system can show the same statistical information as stock trading systems show for the stock market. Examples of such statistics include bid-offer spread (also known as bid-ask or buy-sell spread), sale quotes, order quantity, trading volume, and historical values of the same.

The external payment or payment gateway functionality can provide features that enable other services to make payments using virtual currency. The payment gateway functionality can include a channeling service that permits payment for non-game digital contents provided by the owner of the system or by a partner of the owner of the system. Likewise, the channel service can provide a payment method for game goods in games. The payment gateway functionality can also permit virtual currency to be used as a payment method for other content providers.

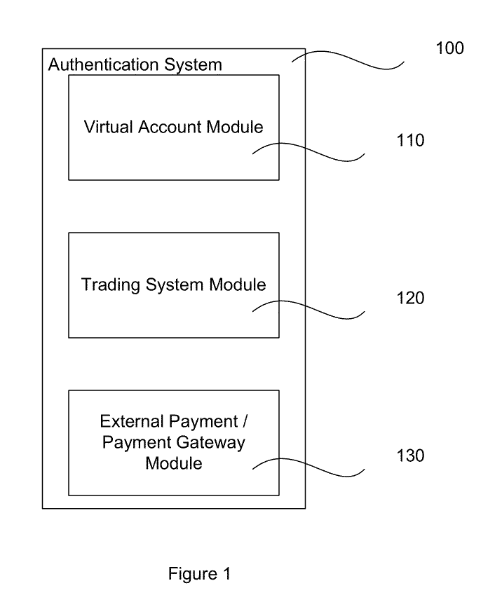

FIG. 1 provides an illustration of a system according to certain embodiments. As shown in FIG. 1, an authentication system 100 can include a virtual account module 110. The virtual account module 110 can implement the virtual account functionality described above. Thus, the virtual account module 110 can be configured to maintain accounts, provide transfer of virtual currency between accounts, and provide for conversion between cash and virtual currency.

A trading system module 120 can also be included in the authentication system 100. The trading system module 120 can implement the trading system functionality described above. Accordingly, for example, the trading system module 120 can perform auto-matching of trades, can provide an operations system for instant trade and deposit, and can provide statistics regarding trades.

Furthermore, an external payment/payment gateway module 130 can implement the external payment/payment gateway functionality described above. Thus, for example, the external payment/payment gateway module 130 can provide channeling service and serve as a payment gateway module for other content sites.

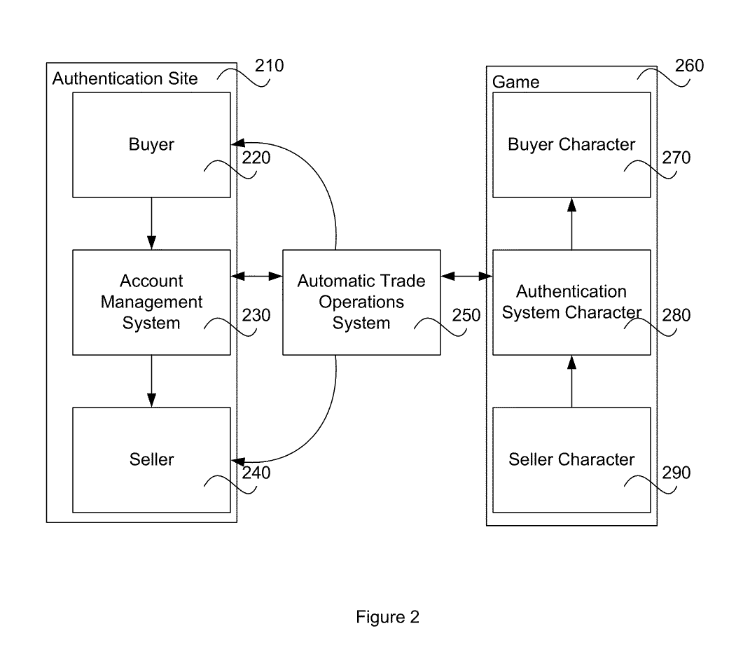

FIG. 2 illustrates a partially integrated system according to certain embodiments. As shown in FIG. 2, a system can include an authentication site 210, an automatic trade operations system 250, and a game 260. There may be partial integration of these components. For example, there may be full integration between the authentication site 210 and the automatic trade operations system 250, but only limited integration with the game 260.

The authentication site 210 can be visited by a buyer 220 and a seller 240. The authentication site 210 can serve as an interface for communication with the buyer 220 and seller 240.

The authentication site 210 can include an account management system 230. The account management system 230 can use a virtual currency instead of real currency. This virtual currency can be purchased with real currency or exchanged into a real currency. There is no requirement that the same real currency used to purchase the virtual currency also be used to sell back the virtual currency. The virtual currency can be transferred automatically through the automatic trade operations system 250 when needed. Thus, traders are not required to handle money when making transfers.

For example, the buyer 220 can provide virtual currency to the account management system 230 in order to make a trade. When the trade is complete, the virtual currency can be provided to the seller 240.

The automatic trade operations system 250 can serve as a core system of the infrastructure and can support other functionality, including escrow service and automated transfer processing of an item. More discussions of the automatic trade operations system 250 will be described below.

Within the game 260, the seller character 290 can provide game money and other items to the authentication system character 280. This authentication system character 280 can be a single character or a variety of coordinate characters. For example, a broker character can be used to receive the game money or other goods from the seller character 290.

The authentication system character 280 can also deposit the game money or other item in some alternative repository, such as a storage character or in-game safe deposit box, or other inventory security mechanism. The seller character 290 can provide the game money or other items to the authentication system character 280 before the sale transaction occurs. Thus, the authentication system character 280 can be configured to escrow the items received from the seller character 290 until the sale transaction clears.

The seller 240 can coordinate the actions of the seller character 290 and the buyer 220 can coordinate the actions of the buyer character 270, while the Automatic trade operations system 250 can coordinate the automatic procedures of the account management system 230 and the authentication system character 280.

When a sale transaction clears, the authentication system character 280 (e.g., a delivery character) can provide the game money or other items to the buyer character 270 within the game 260.

The automatic trade operations system 250 can provide automated trade matchmaking between buyer 220 and seller 240. Thus, the automatic trade operations system 250 can permit the transaction to occur automatically, after a deposit of the item in the game 260 and the virtual currency within the authentication site 210 has been performed.

The automated trade matchmaking can avoid providing a whole-selling list dealing with the same item. However, the automated trade matchmaking can show market conditions like sales, purchase quotes list, recent deals, and changes of volume and price. The buyer 220 does not need to choose specific deals or contact the seller 240. Instead, the buyer 220 can purchase the desired amount of a specific item. A buyer 220 that wants a better price than currently offered can submit a bid and wait to be matched to a seller 240.

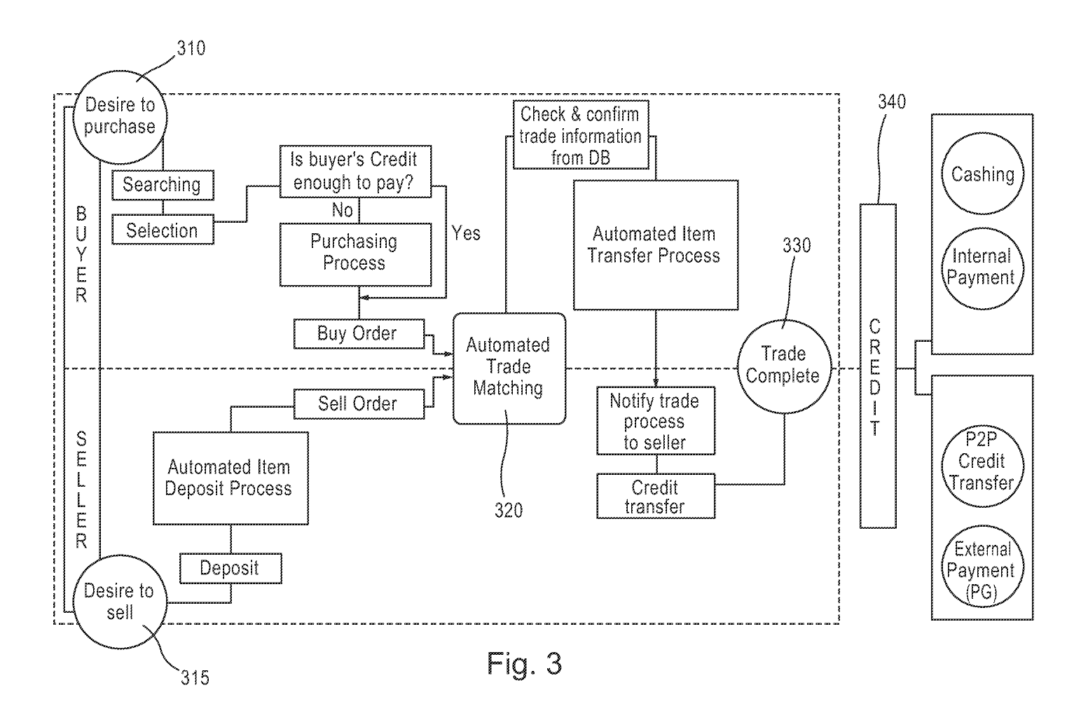

FIG. 3 illustrates a flow diagram of functionality according to certain embodiments. As shown in FIG. 3, the functionality can begin at 310 with a desire by a buyer to purchase and/or at 315 with a desire by a seller to sell. The buyer can search using an interface for a desired item and then make a selection. Next, an authentication system can verify whether buyer's credit (calculated in terms of virtual currency, for example) is sufficient to make the desired purchase. If so, a buy order can be created. If not, a purchasing process can be initiated to permit the buyer to obtain more credit.

Likewise, the seller can make a deposit of an item, such as game gold, armor, rings, or other items. An automated item deposit process can transfer that item into a pool. The pool can be an escrow account or simply a collection of like goods. If a mixture of various items is deposited, they can each be placed in different pools or in the same seller escrow pool. The seller can also provide to an interface the asking price for the items, and other information regarding the items, such as information used to confirm that the items are not hacked. The confirming of hacked items may occur when system is being operated in cooperation with a game publisher. A hacked item may be an item that has been altered or created in a way that violates the rules of the game or other program to which the item belongs.

Once deposit of the items has been verified in the authentication system by the automated item deposit process, and the authentication system has determined the asking price(s) for the items, a sell order can be created. It is not critical that the asking price be provided prior to depositing the items. Moreover, the seller may retain the ability to change the asking price if a sale transaction remains pending for a period of time. This change in asking price can be configured to occur manually or automatically.

The sell order and the buy order can be provided to the automated trade matching, at 320. There is no requirement that the buy order and the sell order be submitted to the automated trade matching at the same time.

Next, the authentication system can check and confirm trade information from a database (DB). Then, the authentication system can perform an automated item transfer process, notify the seller of this trade process, and transfer credits. Finally, at 330, the trade may be complete.

After the trade is complete, at 340, a post-trade credit process can be initiated. The post-trade credit process can involve cashing out of the virtual credit or virtual currency, internal payment, player to player (P2P) credit transfer, or external payment/payment gateway (PG) functionality. This post-trade credit process can be separated from the trading process, such that it is not necessary that trading occur for the credit transactions to occur.

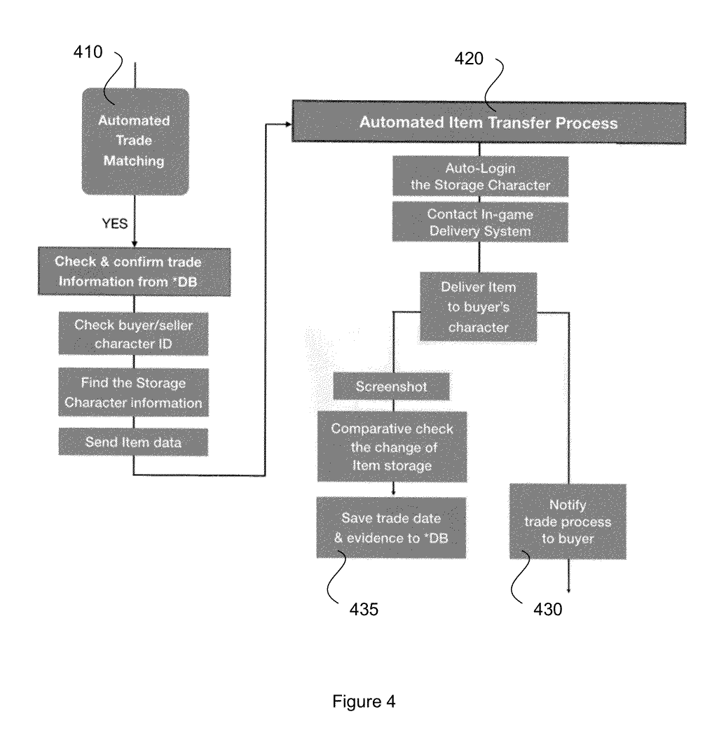

FIG. 4 illustrates automated item transfer according to certain embodiments. As shown in FIG. 4, the automated item transfer can be triggered at 410 when automated trade matching yields a positive (“YES”) outcome. Under this circumstance, the authentication system can check and confirm trade information from database (DB). Then the authentication system can check the buyer and/or seller character identification (ID), e.g., their account numbers, usernames, locations, description of avatar, or other identification information. Since the item may already be received from the seller, it may not be necessary to check the seller character identification at this stage. The authentication system can then identify storage character information (if the item being exchanged was stored in a storage character) and send that item date to the automated item transfer process.

At 420, the automated item transfer process can then auto-login a character (for example, a storage character) and/or contact an in-game delivery system and deliver the item to the buyer's character in the game. Then, at 430, the buyer can be notified of the trade process and the functionality can end from the standpoint of the buyer. Of course, it is possible for the buyer to be notified earlier, particularly so as to obtain the buyer's cooperation in locating the buyer's character within the game.

The process can continue internally by taking a screenshot of the deposit transaction and performing a comparative check of a change of item storage inventory. The trade date and evidence can be saved to a database, at 435, and this can conclude the process from an internal standpoint. This evidentiary process may not be necessary, but may help to authenticate the transaction from the standpoint of the owner or operator of the authentication system, as well as to an outside auditor or a complaining customer.

Various techniques can be used to automate the delivery of the item to the buyer's character. For example, text and image recognition can be used to permit the authentication system to navigate a game, locate the buyer's character and interact with the buyer's character. From the buyer's side and/or the authentication system's side, a script can be employed to enable the buyer's character to quickly and efficiently connect with the delivery character providing the item. Alternatively, in-game mail delivery can be employed to automatically transmit the item to the buyer's character or to return the item to the seller's character if no purchase transaction is completed. The authentication system can be configured to employ automated game input. Automated game input can be used with respect to various things, such as log-in, choosing characters, mailboxes, and so on. Macros or other scripts can, for example, be used to automate procedures within the game.

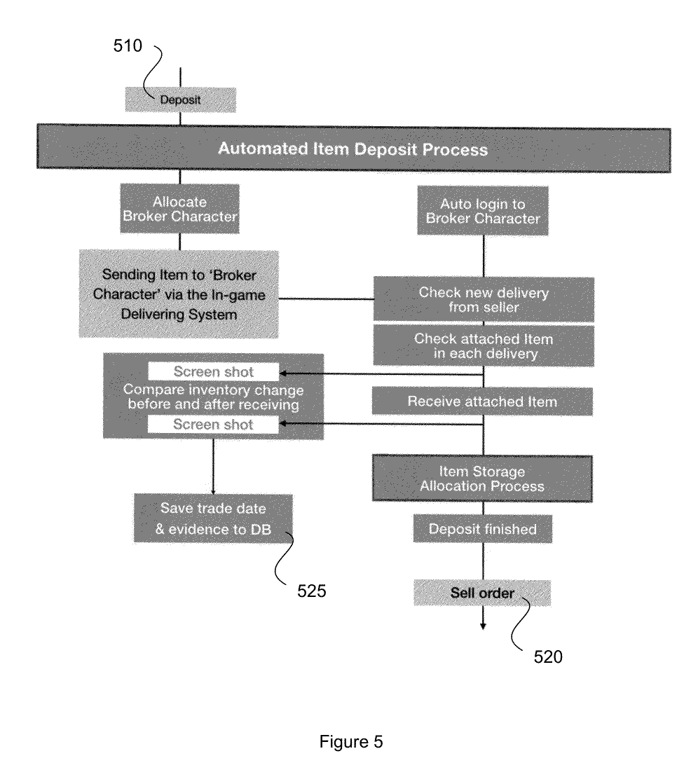

FIG. 5 illustrates an automated item deposit according to certain embodiments. As shown in FIG. 5, the automated item deposit process can be triggered at 510 by the attempt of a seller to deposit an item. The authentication system can allocate a broker character to receive the item. Then, the seller can send the item to the broker character via an in-game delivery system, such as a face to face exchange or email. If a broker character is already allocated, that broker character can be auto-logged-in.

Then, the authentication system can check for a new delivery from a seller. When a new delivery is detected, the authentication system can check each attached item in the delivery. The authentication system can indicate the item as received, and—in parallel—can document the process of receiving the item, which can be known as a receipt of item process. This receipt of item process can be omitted, but may be used for authenticating the delivery transaction for an owner of the authentication system, an auditor, or a complaining customer. That receipt information including the trade date and evidence can be saved to a database (DB) at 525.

Meanwhile, an item storage allocation process can be employed to store or escrow the deposited item pending sale and transfer of the item. At this point, the deposit may be finished. Once an asking price for the item(s) has been identified, a sell order can be generated at 520. Alternatively, a sell order can be generated automatically, based on current market conditions.

The automated item deposit process can employ text and image recognition, automated game input, and exact cognition and input as an automated item transfer process as described above. There is no requirement that the automated item transfer process and the automated item deposit process operate similarly. This is just an example for the purposes of illustration, as are all embodiments set forth herein.

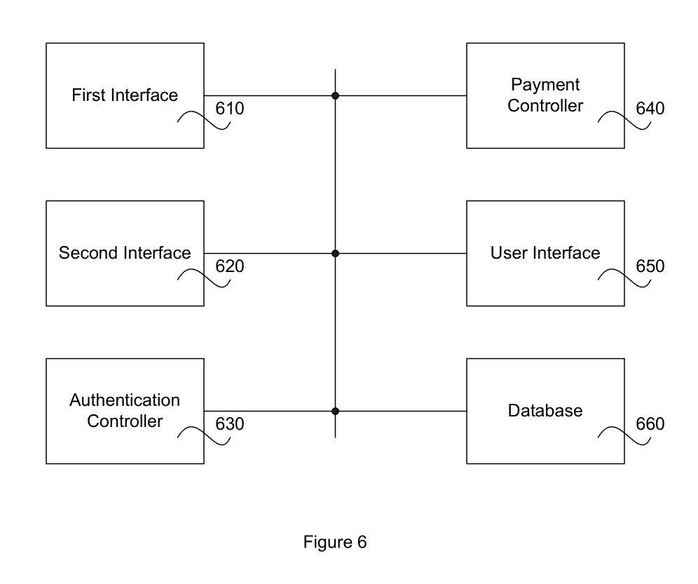

FIG. 6 illustrates an apparatus according to certain embodiments. As shown in FIG. 6, an apparatus (for example, an authentication server) can include a first interface 610, a second interface 620, and an authentication controller 630.

The first interface 610 can be configured to communicate with a first user, for example, the seller of an item. For example, the first interface 610 can communicate with the first user via a website. The first interface 610 can be configured to query the first user for a username and password. The first interface 610 can be configured to obtain other identification information, such as biometric identification information.

Likewise, the second interface 620 can be configured to communicate with a second user, for example, the buyer of an item. For example, the second interface 620 can communicate with the second user via a website and can be configured to query the second user for a username and password. The second interface 620 can be configured to obtain other identification information, such as biometric identification information, of the second user.

The first interface 610 and the second interface 620 can be the same interface or they can be different interfaces. For example, the first interface 610 can be a website belonging to an owner of the authentication server, while the second interface 620 can be an in-game interface based on, for example, an application programming interface (API) provided by the owner of the authentication server.

The authentication controller 630 can be configured to authenticate the first user based on a first deposit of a first item. The first interface 610 can be configured to receive the first deposit from the first user. The first item can be an item being offered for sale. The item can include, for example, game gold or credit, virtual equipment such as swords and armor, or virtual property, such as a house or castle. The first interface 610 can be configured to receive the first deposit by an in-game transfer, by an email transfer, or by any other mechanism. A broker character within a game can be employed to receive the deposit. The broker character can be a user identity within a game and can appear to be another player to players of the game.

For example, in a particular embodiment, a sword can be deposited into a pool of like swords. The term “pool” here can refer to a grouping of items. Thus, a pool of like swords is a grouping of like swords. This grouping can be maintained via a database or within a game by being stored in a particular character's or store's inventory. The authentication controller 630 can be configured to account for the deposit of the sword and to return a like sword (or even the same sword) to the first user if a transaction fails.

The authentication controller 630 can also be configured to authenticate the second user based on a second deposit of a second item. The second interface 620 can be configured to receive the second deposit from the second user. The second item can be an item being offered as a way of buying. For example, the second item can be a virtual currency or a salable item. The deposit of the virtual currency can be accomplished by purchasing virtual currency with real currency, earning virtual currency through performing some task (such as an in-game quest), obtaining virtual currency by a promotion (for example, as a reward for recommending a service to several friends), as proceeds from selling an item, or any other way. The deposit of the virtual currency can be a deposit in an account belonging to the second user, or in a holding account to ensure that sufficient virtual currency is available for a specific transaction.

Virtual currency can refer to credits, tokens, or similar countable items that have assigned value within a system, but are not government-issued currency. For example, within a game, game gold or game dollars may be used to purchase items at stores of the game. Such game gold may be one kind of virtual currency. Other kinds of virtual currency are also possible. The authentication system may employ its own virtual currency that is independent of the virtual currency of any particular game. Examples of real currency can include U.S. Dollars, South Korean Won, Euros, Japanese Yen, Swiss Francs, Russian Rubles, and so on. As an alternative to government issued currency, precious metals (for example, gold, silver, or platinum) or other commodities can be substituted.

In a specific instance, virtual currency can be deposited in the second user's personal account. Then, when the second user wishes to conduct a transaction, an amount of a bid (or other proposed payment amount) of the second user is deposited into an escrow account that holds the amount of the bid until the transaction either succeeds or fails.

The authentication controller 630 can be configured to transfer the first deposit to a first pool. The first pool can be a pool of similar goods, or simply a pool of items for sale or other exchange. Alternatively, the first pool can be an escrow pool corresponding to the first user. Thus, in a specific example, multiple items from the same user that are being offered for sale or exchange can be pooled in a first pool. In another example, however, the first deposit may be placed into a pool of like goods. For example, gold for a particular game can be placed in a single pool.

In the case of a first deposit that includes a group of items (including the first item), the first interface 610 can be configured to query the first user regarding the severability of the group of items. For example, the first user can be queried as to whether the items in the group can be sold or exchanged separately or whether they must be sold as a group. In the case of game gold, for example, the selling user may be given the option to sell “all or nothing” to sell sub-units of a group of game gold that is being offered for sale. The authentication controller 630 can maintain the information provided in response to this and other queries from the first interface 610 and second interface 620.

The authentication controller 630 can be configured to transfer the second deposit to a second pool. As mentioned above, this second pool may be a user's account of virtual currency, or an escrow account for the user.

The authentication controller 630 can be further configured to authenticate an exchange transaction between the first user and the second user. The authentication of the exchange can include automatically matching a first parameter obtained by the first interface 610 from the first user to a second parameter obtained by the second interface 620 from the second user.

The first parameter can include one or more item. For example, the first parameter can include an asking price, a sell-by date, an automatic de-escalation amount, a minimum asking price, or any combination thereof. The asking price can be the amount that the first user wishes to receive for the first item. The sell-by date can be the length of time that the first user wants the item to remain available for sale. The automatic de-escalation amount can be an amount of discount to be applied if the first item has not sold within a predetermined period of time. The automatic de-escalation amount can be specified to result in multiple discounts of the same item over time until the item is sold. A minimum asking price can be set to ensure that the asking price does not automatically go too low for the first user.

The second parameter can also include one or more item. For example, the second parameter can include an offer price, a duration of the offer, an automatic escalation amount, a maximum offer price, or any combination thereof. The offer price can be the amount that the second user is willing to give for an item to be obtained. The duration of the offer can be the length of time for which this offer is good, and after which the offer is to be withdrawn. The automatic escalation amount is the amount to which the offer or bid should be increased if a sale is not completed within a predetermined period of time. A maximum offer price can be set to avoid the second user automatically overpaying for an item of interest.

The matching the first parameter to the second parameter can include matching an ask price to a bid price. The matching can be an exact matching or an inexact matching For example, a bid price can be matched to an ask price that is at most equal to the bid price.

The authentication controller 630 can be configured to transfer a third item from the first pool to the second user. The third item can be the same item as the first item or a different item of the same kind. The transfer of the third item can take place in a variety of ways, such as within the gaming environment or a persistent world (in game) or by email.

Likewise, the authentication controller 630 can be configured to transfer a fourth item from the second pool to the first user. The fourth item can be the same item as the second item, or a different item of the same kind. For example, the first pool can be a pool of identical castles and the second pool can be a pool of virtual currency.

Various techniques can be used by the first interface 610, second interface 620, and authentication controller 630 to receive, store, and deliver items. For example, the first interface 610 can receive the first item with the broker character. The broker character can be present in a game in which the first item is able to be used and exchanged. The broker character can be obtained by registering the broker character with the game as a user of the game. Likewise, the second interface 6 can use a delivery character to delivery the third item to the second user. The authentication controller 630 can use a storage character to store the first item. Moreover, multiple broker, delivery, and storage characters can be used within a single game and across multiple games. Like the broker character(s), the delivery and storage character(s) can be generated within the game or within multiple games.

The apparatus can further include a payment controller 640. The payment controller 640 can be configured to perform an exchange between real currency and virtual currency. For example, referring to the embodiment described above, the second item can be the virtual currency.

The payment controller 640 can be configured to verify whether the second user has sufficient virtual currency to perform a transaction and to top up the virtual currency of the second user when the second user does not have sufficient virtual currency.

“Topping up” can refer to a procedure of increasing the amount of virtual currency in an account to a predefined “top-to” level, when the level of virtual currency in the account is either below the top-to level, or below some minimum threshold amount. For example, a top-to level can be set to be an initial amount in the account when the account is opened, and a minimum threshold amount can be set to be one-half the top-to level.

The payment controller 640 can be configured to convert real currency to virtual currency according to a first rate and can be configured to convert virtual currency to real currency according to a second rate that differs from the first rate. For example, the payment controller 640 can convert from real currency to virtual currency at a 1:1 rate, but can convert from virtual currency to real currency at a 1:0.9 rate.

The authentication controller 630, first interface 610, and second interface 620 can be configured to conceal all personal information regarding the first user from the second user and all personal information regarding the second user from the first user. Likewise, the payment controller 640 can be similarly configured with respect to all personal information.

The apparatus can additionally include a user interface 650 configured to provide trading information regarding the first pool to the second user. The second interface 630 can be configured to receive a purchase selection from the second user after display of the trading information.

For example, if the first pool is a pool of armor of specific level for use by a player's character within a game, the trading information may include the range of asking prices for that pool of armor, volume of trading for that pool of armor, and number of available armor units. For each asking price, the number of available units of armor can be shown. The second user can then select a number of units of armor to purchase and a price that the second user is willing to pay. When a match occurs between the price the second user is willing to pay and the price that a first user is willing to accept, the authentication controller 630 can automatically authenticate the transaction and move the transaction to settlement.

A database 660 can be configured to record, track, and provide the trading information corresponding to the first item, the second item, the first pool, and the second pool.

The first interface 610 and the second interface 620 can be placed in communication with a persistent world. The persistent world can be a virtual world in which users' changes to the world's state continue to exist even after the users who made the changes leave the world. In a particular example, the persistent world is the arena of play of a massively multiplayer on-line role playing game.

The authentication controller 630 can be configured to generate, in the persistent world, a plurality of in-game characters for communicating with a plurality of users in the persistent world including the first user and the second user and configured to conceal all personal information of the first user from the second user. The plurality of in-game characters include a first in-game character configured to receive the first item from the first user, and a second broker character configured to deliver the fourth item to the second user.

In a particular embodiment, the authentication controller 630 is configured to broker an exchange between a buyer and a seller, wherein the buyer and the seller are in communication with a persistent world. The authentication controller 630 is configured to generate in-game characters for communicating with the buyer and seller in the persistent world. The authentication controller 630 is also configured to authenticate the seller based on a first item received from the seller by way of a first generated in-game character configured to communicate with the seller in the persistent world. The authentication controller 630 is further configured to transfer the first item to a first storage containing a plurality of the first item. The authentication controller 630 is additionally configured to transfer virtual currency from a buyer from a first external account outside the persistent world to an escrow account. The authentication controller 630 is also configured to authenticate an exchange transaction between the buyer and the seller, wherein the exchange transaction is performed based on matching an asking price from the seller with an offer price from the buyer. The authentication controller 630 is further configured to transfer the first item from the first storage to the buyer by way of a second generated in-game character configured to communicate with the buyer in the persistent world. The authentication controller 630 is additionally configured to transfer virtual currency to a second external account linked to the seller outside the persistent world.

The first interface 610, second interface 620, authentication controller 630, payment controller 640, user interface 650, and database 660 are illustrates as separate components connected by a bus connection. However, the components are can be combined, such that, for example, the first interface 610 and the second interface 620 can be the same, or one of those interfaces can be the user interface 650. Likewise the authentication controller 630 and payment controller 640 can be the same component. Moreover, the interconnection amongst the components can be other than illustrated in FIG. 6.

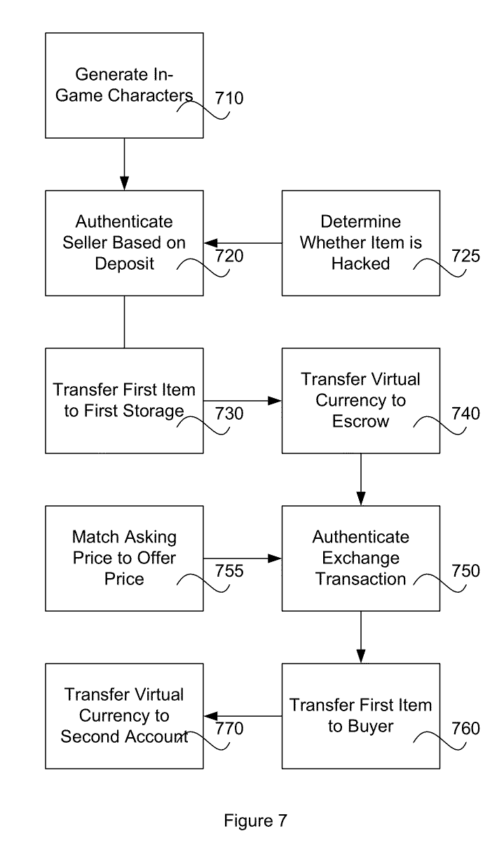

FIG. 7 illustrates a method according to certain embodiments. As illustrated in FIG. 7, a method can be a method of authenticating and brokering an exchange between a buyer and a seller. The buyer and the seller can be in communication with a persistent world. An authentication controller can, at 710, generate in-game characters for communicating with the buyer and seller in the persistent world.

An authentication system can generate a character within a world in a variety of ways. For example, an authentication system can automatically login a previously created character or can register a new character within the world. Alternatively, a new character can be spawned automatically within the world through cooperation with the game provider. The authentication system can provide identifying information about the created character to one or more of the parties of the transaction. Thus, the authentication system can interact with the persistent world via a client like the parties of the transaction. Alternatively, the authentication system can be integrated more or less fully with the game.

The authentication controller can also, at 720, authenticate the seller based on a first item received from the seller by way of a first generated in-game character configured to communicate with the seller in the persistent world. Optionally, at 725, the first item is authenticated to determine whether the first item is hacked. The authentication controller can further, at 730, transfer the first item to a first storage containing a plurality of the first item.

The authentication controller can additionally, at 740, transfer virtual currency from a buyer from a first external account outside the persistent world to an escrow account. The authentication controller can also, at 750, authenticate an exchange transaction between the buyer and the seller. The exchange transaction can be performed based on, at 755, matching an asking price from the seller with an offer price from the buyer.

The authentication controller can further, at 760, transfer the first item from the first storage to the buyer by way of a second generated in-game character configured to communicate with the buyer in the persistent world. The authentication controller can additionally, at 770, transfer virtual currency to a second external account linked to the seller outside the persistent world.

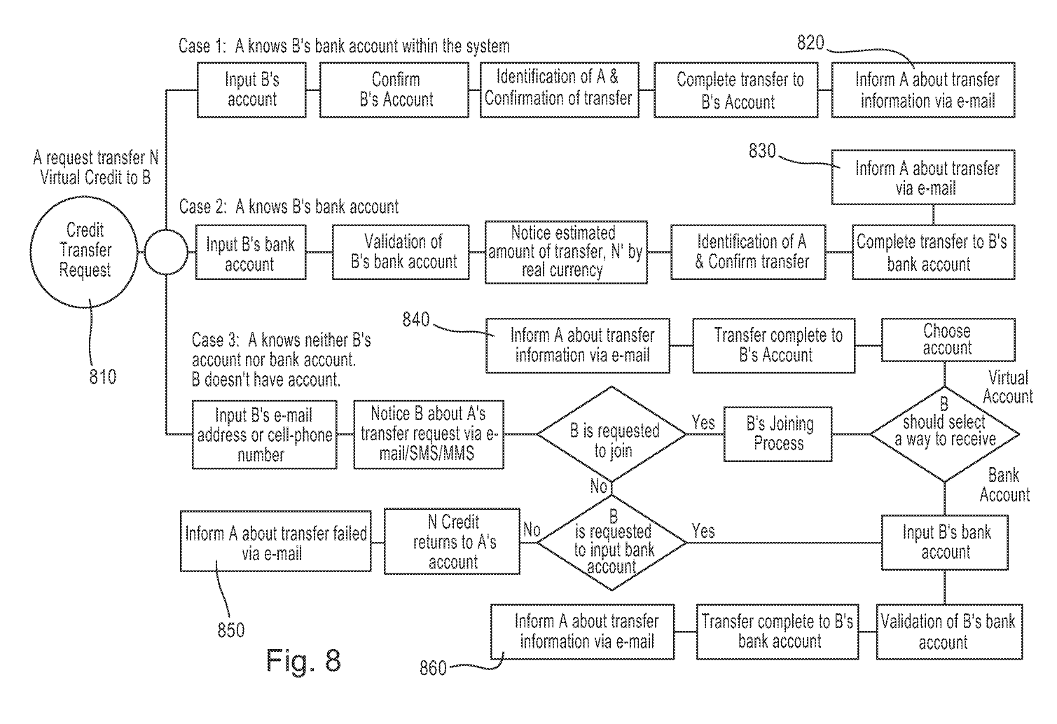

FIG. 8 illustrates a credit transfer process according to certain embodiments. As shown in FIG. 8, a credit process can begin at 810 with a request to transfer N virtual credits from user A to user B. In a first case, A knows B's account within the system. In this case, A inputs B's account, that account is confirmed, A is identified and the transfer is confirmed with A, then the transfer is completed to B's account, and A is informed about the transfer, for example via email, at 820.

In a second case, A knows B's bank account. In this case, A enters B's bank account. B's bank account is validated by the system. Then, a notice is provided of estimated amount of transfer, enumerated in a real currency. Identification of A and confirmation of the transfer are performed, and then the transfer to B's bank account is completed. Finally, at 830, A is informed about the transfer via email.

In a third case, there are several options. In a first option, A does not know any account information for B. Thus, in this case, A inputs B's email address or cell phone number. B is notified that A wants to transfer to B's account. This notice can be provided by, for example, email, SMS, or MMS. B is requested to join. When B accepts this offer, B joins and then is offered a way to receive the funds. B can then select a virtual account and the funds can be transferred to B's virtual account. At 840, A can be notified about the successful transfer.

In a second option, the same procedure can be followed, except that B can select to deposit in B's bank account. In this case, B can input B's bank account number. Then the bank account can be validated and the transfer can be completed to B's bank account. Finally, at 860, A can be notified of the successful transfer.

In a third option, B can refuse to join and can select to have the funds transferred to B's bank account. In such a case, B can input B's bank account information, and the procedure can proceed to 860, as in the previous option.

Finally, in a fourth option, B can refuse to join and can refuse to provide bank account information. In this case, the N credits can be returned to A's account. At 850, A can be informed about the failed transfer.

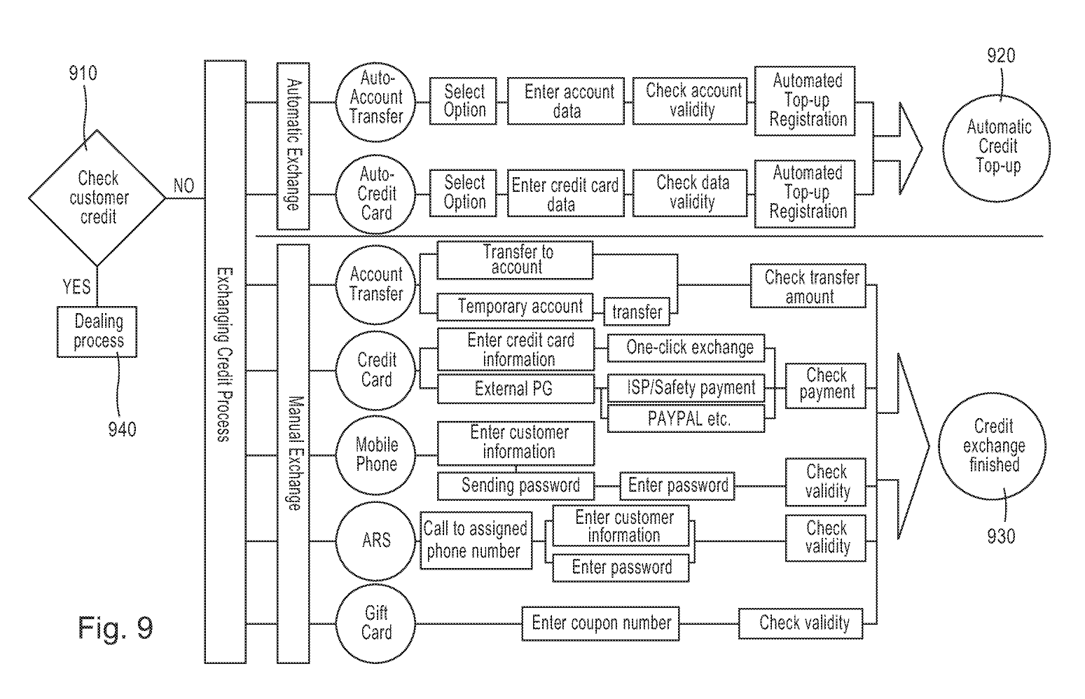

FIG. 9 illustrates a credit exchange process according to certain embodiments. As shown in FIG. 9, if a customer does not have sufficient credit (for example, virtual currency), an exchanging credit process can be performed. The process can be either an automatic exchange or a manual exchange. An auto-account transfer can be performed in which an option for auto-account transfer has been selected and account data (for example, bank account data) has been entered. Then, the account's validity can be checked and an automated top-up registration can be instituted. In this case, at 920, automated credit top-up can be performed. Likewise, a credit card can be used instead of a bank account, and a similar process can proceed to automatic top-up at 920.

Alternatively, manual account transfer can be performed. For example, credit from one virtual account be transferred to another virtual account, and the credit exchange can be finished at 930. Optionally, a temporary account can be used in the course of such a transfer.

A credit card can be manually used to provide credit. The credit card can either be processed by a one-click exchange or by an external payment gateway (PG), such as PayPal® or the like. As before, the credit exchange can be finished at 930.

Further alternatives are to use a mobile phone or an audio response system (ARS) to make initiate the credit transfer. In the case of a mobile phone, a password can be provided and entry of the password can be used to authorize the credit exchange. In the case of the ARS, an assigned phone number can be called and customer information and password can be provided to authorize the credit exchange. Finally, the credit exchange can be finished at 930.

A final alternative is the use of a gift card or other coupon. In this case, the coupon number can be entered. Then, the validity of the coupon number can be checked. If the number is valid, the credit exchange can be finished at 930.

In another option, an additional credit exchange process can be used. For example, another virtual currency can be converted into the virtual currency used within the system. The process can proceed similar to that for processing a giftcard or coupon.

If the check of the customer's credit indicates sufficient credit, the credit exchange can be omitted. In this case a dealing process can be initiated directly at 940. The dealing process can also be initiated after the credit exchange or automatic credit top-up is completed.

Embodiments of the present invention may have various features. For example, certain embodiments may permit real-time, on-line trade and settlement during all hours of the day and all days of the year. Certain embodiments may also allow immediate trade and settlement of virtual items. Moreover, there can be, in certain embodiments, a perfect match and settlement between buy & sell (bid & offer). There can be transparency in the process of purchase, as the buyers and sellers may able to make an assessment of the market before asking or bidding. The virtual currency of certain embodiments may be convertibility into real money. Moreover, in certain embodiments, transaction costs may be kept low.

Thus, certain embodiments may employ matching escrow account(s) at AAA-rated banks. Moreover, virtual credit/currency to be issued based on cash deposit (into an escrow account). The virtual credit/currency can be the exclusive way by which all trades are settled within the system. This system can avoid default, because any and all virtual credit/currency can be converted unconditionally upon demand into real cash. Moreover, all items traded within the system can be coded, as in real-world stock-exchanges (e.g., NASDAQ and most of the major securities exchanges around the world). Likewise, certain embodiments can provide a real-time screen showing all the items with bid & offer; by price and volume; all by computer trading round the clock. Moreover, all electronic and real-time transfer of items and virtual credit/currency as well as conversion into real money among all the accounts can take place within the system.

Moreover, in certain embodiments, production of real-time, on-line statements showing all transactions and account balances in items and virtual credit/currency as well as cash can be provided to users. Furthermore, certain embodiments may be capable of sending and receiving items (including virtual credit/currency as a special case), and cash to and from different games, gamers' bank accounts, and credit card accounts.

Various methods have been described above. These methods can be implemented in hardware alone or in hardware running software. Thus, for example, the methods and functionalities can be implemented in the form of a non-transitory computer-readable medium encoded with instructions that, when executed in hardware, perform a process, the process corresponding to the above-described methods and functionalities. Other implementations are also possible.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. An apparatus for use as an authentication server, comprising:
a first interface configured to communicate with a first user;
a second interface configured to communicate with a second user; and
an authentication controller configured to
authenticate the first user based on a first deposit of a first item,
authenticate the second user based on a second deposit of a second item,
transfer the first deposit to a first pool, wherein the first pool contains a plurality of the first item,
transfer the second deposit to a second pool wherein the second pool contains a plurality of the second item,
authenticate an exchange transaction between the first user and the second user,
transfer a third item from the first pool to the second user, and
transfer a fourth item from the second pool to the first user.

2. The apparatus of claim 1, wherein the first interface is configured to query the first user for username and password.

3. The apparatus of claim 1, wherein the second interface is configured to query the second user for username and password.

4. The apparatus of claim 1, wherein the first interface is configured to receive the first deposit from the first user.

5. The apparatus of claim 1, wherein the second interface is configured to receive the second deposit from the second user.

6. The apparatus of claim 1, wherein the first interface is configured to query the first user regarding the severability of a group of items including the first item.

7. The apparatus of claim 6, wherein the group of items comprises a plurality of identical units of a same item as the first item.

8. The apparatus of claim 1, wherein the first interface is configured to query the first user regarding a first parameter for exchange of the first item.

9. The apparatus of claim 8, wherein the first parameter comprises at least one of an asking price, a sell-by date, an automatic de-escalation amount, or a minimum asking price.

10. The apparatus of claim 1, wherein the second interface is configured to query the second user regarding a second parameter for exchange of the second item.

11. The apparatus of claim 10, wherein the second parameter comprises at least one of an offer price, a duration of the offer, an automatic escalation amount, or a maximum offer price.

12. The apparatus of claim 1, wherein the authentication controller is configured to match a first-user-determined first parameter regarding the first item with a second-user-determined second parameter regarding the second item and to authenticate the exchange transaction based on the match.

13. The apparatus of claim 12, wherein the authentication controller is configured to match the first parameter to the second parameter by matching an ask price to a bid price, respectively.

14. The apparatus of claim 1, wherein the first interface is further configured to receive the first item with a broker character.

15. The apparatus of claim 1, wherein the authentication controller is configured to store the first item in a storage character.

16. The apparatus of claim 1, wherein the authentication controller is configured to deliver the third item in a delivery character.

17. The apparatus of claim 1, further comprising a database, wherein the database is configured to track the first item, second item, first pool, and second pool.

18. The apparatus of claim 1, further comprising a payment controller, wherein the payment controller is configured to perform an exchange between a real currency and a virtual currency, wherein the second item comprises the virtual currency.

19. The apparatus of claim 18, wherein the payment controller is configured to verify whether the second user has sufficient virtual currency to perform a transaction and to top up the virtual currency of the second user when the second user does not have sufficient virtual currency.

20. The apparatus of claim 18, wherein the payment controller is configured to convert real currency to virtual currency according to a first rate and is configured to convert virtual currency to real currency according to a second rate that differs from the first rate.

21. The apparatus of claim 1, wherein the authentication controller, first interface, and second interface are configured to conceal all personal information regarding the first user from the second user and all personal information regarding the second user from the first user.

22. The apparatus of claim 21, wherein the first interface and the second interface are in communication with a persistent world, and wherein the authentication controller is configured to generate, in the persistent world, a plurality of in-game characters for communicating with a plurality of users in the persistent world including the first user and the second user and configured to conceal all personal information of the first user from the second user, wherein the plurality of in-game characters include a first in-game character configured to receive the first item from the first user, and a second broker character configured to deliver the fourth item to the second user.

23. The apparatus of claim 1, further comprising a user interface configured to provide trading information regarding the first pool to the second user, wherein the second interface is configured to receive a purchase selection from the second user after display of the trading information.

24. The apparatus of claim 1, further comprising a database configured to record, track, and provide the trading information corresponding to the first item, the second item, the first pool, and the second pool.

25. An apparatus for authenticating a transaction, comprising:
an authentication controller configured to broker an exchange between a buyer and a seller, wherein the buyer and the seller are in communication with a persistent world,
wherein the authentication controller is configured to
generate in-game characters for communicating with the buyer and seller in the persistent world,
authenticate the seller based on a first item received from the seller by way of a first generated in-game character configured to communicate with the seller in the persistent world,
transfer the first item to a first storage containing a plurality of the first item,
transfer virtual currency from a buyer from a first external account outside the persistent world to an escrow account,
authenticate an exchange transaction between the buyer and the seller, wherein the exchange transaction is performed based on matching an asking price from the seller with an offer price from the buyer,
transfer the first item from the first storage to the buyer by way of a second generated in-game character configured to communicate with the buyer in the persistent world, and
transfer virtual currency to a second external account linked to the seller outside the persistent world.
